(19) United States
(12) Patent Application Publication
(10) Pub. No.: US 2025/0149840 A1
(43) Pub. Date: May 8, 2025

(54) QUICK-COUPLING ELECTRICAL FIXTURE ASSEMBLY

(71) Applicant: David S. Lowry, Akron, OH (US)

(72) Inventor: David S. Lowry, Akron, OH (US)

(21) Appl. No.: 18/940,370

(22) Filed: Nov. 7, 2024

Related U.S. Application Data
(60) Provisional application No. 63/596,630, filed on Nov. 7, 2023.

(51) Int. Cl. H01R 33/94

(52) U.S. Cl. CPC H01R 33/94

(57) ABSTRACT

An electrical fixture connector assembly, including a base assembly having a male shell and a first electrical core; wherein the first electrical core is configured to nest within the male shell; wherein the first electrical core is configured to accept electrical wires from an electrical outlet or junction box; a housing assembly having a female shell and a second electrical core; wherein the second electrical core is configured to nest within the female shell; and wherein the second electrical core is configured to accept electrical wires from an electrical fixture; wherein the first and second cores are configured to mate with one another to form an electrically conductive connection; wherein the male and female shells are configured to mate with one another to form a load-bearing mechanical connection.

### BACKGROUND OF THE INVENTION

### Technical Field

This invention pertains to the field of suspended electrical fixtures. More particularly, the invention pertains to the field of replacement and modification of suspended and other fixture assemblies.

### Description of Related Art

Modification of suspended and hanging electrical fixtures can be a time-consuming, frustrating, and dangerous process. It often requires the installer to use a ladder to reach the fixture, unscrew the fixture from the ceiling junction box, disconnect various electrical wires from the fixture, and lower the fixture down from the ladder. All this must be done while the installer, fixture components, and tools are perched precariously on the rungs of the ladder potentially from dangerous heights. Often, the fixture must be balanced on the top rung of the ladder while the electrical connections are decoupled, resulting in a dangerously unstable situation.

One problem with current suspended electrical fixtures, such as hanging electrical fixtures, is the difficulty of connecting and decoupling the electrical systems. Wires from the junction box are fed, and directly connected, to the fixture, with no intermediary mechanism. The wiring schema can be complicated and require frustrating amounts of time, effort, and expertise to connect and disconnect from the fixture.

Another problem with current suspended electrical fixtures is the difficulty of physically connecting and decoupling the fixture itself. The suspended fixture is moderately heavy and is held aloft by screws or other fasteners that must be undone-often individually-before the fixture can be disconnected from the junction box and lowered from the ceiling.

### BRIEF SUMMARY OF THE INVENTION

The present invention attempts to resolve the forgoing issues by introducing a unique structure and design of electrical fixture assembly and connection that is quick, easy-to-use, and safer than current alternatives. The modular form of this invention may provide users the ability to retrofit existing junction boxes and electrical fixtures, either individually or together. Further, as discussed in the following disclosure, a complete quick-connect base may be fully integrated with a junction box at the time of manufacture, a quick-connect housing may be fully integrated with an electrical fixture at the time of manufacture, or any part of the present invention may be incorporated at the time of manufacture to assist in installation by users to meet the needs of use.

An exemplary electrical fixture connector assembly includes a base assembly having a male shell and a first electrical core; wherein the first electrical core is configured to nest within the male shell. The first electrical core is configured to accept electrical wires from an electrical outlet or junction box; a housing assembly having a female shell and a second electrical core. The second electrical core is configured to nest within the female shell. The second electrical core is configured to accept electrical wires from an electrical fixture. The first and second cores are configured to mate with one another to form an electrically conductive connection. The male and female shells are configured to mate with one another to form a load-bearing mechanical connection.

In one or more embodiments, in the electrical fixture connector assembly, the first electrical core is a female electrical core and the second electrical core is a male electrical core.

In one or more embodiments, in the electrical fixture connector assembly, the first electrical core is a male electrical core and the second electrical core is a female electrical core.

In one or more embodiments, the electrical fixture connector assembly includes a bracket that includes: a center cutout with an inner diameter, a first through-hole, and a second through-hole disposed opposite the first; wherein the center cutout is configured to accept and the hold base assembly.

In one or more embodiments, the electrical fixture connector assembly includes the male shell having a lip section, disposed around a circumference of a top end, a threaded inner surface, a lip extending outwardly from the lip section; the female electrical core having a top section, a recessed mating surface section, and a connecting outer surface disposed around the top and recessed mating surface sections, the connecting outer surface selected from a threaded outer surface and a surface configured to receive one or more set screws; a connection means configured to attach the top section of the female core to the electrical wires from the electrical outlet or junction box; wherein the female core is configured to nest within the male shell by threaded connection between the male shell inner surface and female core outer surface.

In one or more embodiments, the electrical fixture connector assembly can include a bracket that includes a center threaded hole; wherein the male shell further comprises a threaded outer surface disposed around the lip section configured to attach to the center threaded hole.

In one or more embodiments, the electrical fixture connector assembly connection means can be a plurality of wiring screws.

In one or more embodiments, the electrical fixture connector assembly includes the female shell having a bottom end and a connecting interior surface selected from a threaded interior surface and a surface configured to receive one or more set screws; the male electrical core having a bottom section, a mating surface section, and a connecting outer surface disposed between the mating surface and bottom sections, the connecting surface selected from a threaded outer surface and a surface configured to receive the one or more set screws; a connection means configured to attach the bottom section of the male core to the electrical wires from the electrical fixture; wherein the male core is configured to nest within the female shell by a threaded connection between the female shell threaded interior surface and the male core threaded outer surface.

In one or more embodiments, the electrical fixture connector assembly can include an exterior connection surface selected from a threaded exterior surface and a surface configured to receive one or more set screws.

In one or more embodiments, the electrical fixture connector assembly can include a cap having a feed opening oriented downward and a covering section opposite the feed opening; wherein the feed opening and covering section have threaded interior surfaces; wherein the feed opening is configured to connect with the electrical fixture; wherein the cap covers the bottom end of the female shell and secures to the female shell by a threaded connection between the female shell exterior surface and cap cover section threaded interior surface.

In one or more embodiments, the electrical fixture connector assembly connection means can include a plurality of wiring screws.

In one or more embodiments, The electrical fixture connector assembly can include a securement mechanism; a decoupling mechanism; wherein the housing assembly attaches to the base assembly by means of the securement mechanism; and the housing assembly detaches from the base assembly by means of the decoupling mechanism.

In one or more embodiments, the electrical fixture connector assembly can include at least one circular ridge formed in an outer surface of the male shell; a nesting structure disposed on the female shell configured to mate with the at least one circular ridge disposed on the surface of the male shell.

In one or more embodiments, the electrical fixture connector assembly can include a ball-bearing connector configured to mate with the circular ridge to secure the male and female shells together.

In one or more embodiments, the electrical fixture connector assembly nesting structure can include one or more ball bearings configured to mate with the circular ridge to secure the male and female shells together.

In one or more embodiments, the electrical fixture connector assembly securement mechanism includes at least one circular ridge formed in an outer surface of the male shell; at least one sliding disk disposed within the female shell; wherein the at least one sliding disk is configured to shift between an unlocked position and a locked position; wherein the at least one sliding disk is configured to engage with the male shell circular ridge when in the locked position; wherein the at least one sliding disk is connected to the decoupling mechanism; and wherein the decoupling mechanism is configured to engage the at least one sliding disk to shift the disk between the locked and unlocked positions.

In one or more embodiments, the electrical fixture connector assembly securement mechanism can include a biasing mechanism attached to the at least one sliding disk configured to bias the at least one sliding disk to the locked position.

In one or more embodiments, the electrical fixture connector assembly decoupling mechanism includes a plurality of buttons disposed on an outside surface of the female shell; and wherein the buttons are configured to disengage the securement mechanism.

In an exemplary embodiment, an electrical fixture connector assembly, can include a base assembly having a male shell and a female electrical core; wherein the female electrical core is configured to nest within the male shell; wherein the female electrical core is configured to accept electrical wires from an electrical outlet or junction box; wherein the female electrical core is configured to mate with one or more male electrical cores to form an electrically conductive connection; wherein the male shell is configured to mate with one or more female shells to form a load-bearing mechanical connection.

In an exemplary embodiment, an electrical fixture connector assembly, includes a housing assembly having a female shell and a male electrical core; wherein the male electrical core is configured to nest within the female shell; and wherein the male electrical core is configured to accept electrical wires from an electrical fixture; wherein the male electrical core is configured to mate with one or more female electrical cores to form an electrically conductive connection; wherein the female shell is configured to mate with one or more male shells to form a load-bearing mechanical connection.

In accordance with an aspect of the present invention, an electrical fixture connector assembly including a quick-connect bracket, a quick-connect base assembly, a quick-connect housing assembly, a securement mechanism, and a decoupling mechanism. The bracket may be configured to attach to an electrical outlet or junction box. The quick-connect base assembly can have a male shell and a female electrical core, wherein the female core is configured to nest within the male shell. The female core may be configured to accept electrical wires from an electrical outlet or junction box, and the quick-connect base assembly can be configured to connect to the quick-connect bracket. The quick-connect housing assembly attached to the electrical fixture may have a female shell, a male electrical core, and a cap. The male core may be configured to nest within the female shell, and the cap covers at least part of the female shell and may provide several joining, sealing, or aesthetic functions. The male core can be configured to accept electrical wires from an electrical fixture. The quick-connect housing assembly may attach to the quick-connect base assembly by means of the securement mechanism, and the housing assembly may detach from the base assembly by means of the decoupling mechanism.

In accordance with another aspect of the present invention, the electrical fixture connector assembly described above, wherein the quick-connect bracket further includes a center cutout with an inner diameter, a first through-hole, and a second through-hole disposed opposite the first. The cutout inner diameter may be threaded, and the quick-connect bracket may connect to the quick-connect base assembly by means of a threaded connection.

In accordance with another aspect of the present invention, the electrical fixture connector assembly described above, wherein the quick-connect base assembly further includes a lip section on the male shell, disposed around the circumference of a top end, a threaded inner surface, a lip extending outwardly from the lip section, and a threaded outer surface disposed around the lip section. The female electrical core may have a top section, a recessed section, and a threaded outer surface disposed around the top and recessed sections. Additionally, there may be a plurality of wiring screws configured to attach the top section of the female core to the electrical wires from the electrical outlet or junction box. The female core may be configured to nest within the male shell by means of a screwed, threaded connection between the male shell inner surface and female core outer surface.

In accordance with another aspect of the present invention, the electrical fixture connector assembly described above, wherein the quick-connect housing assembly further includes a bottom section on the female shell, a threaded interior surface, and a threaded exterior surface. The male electrical core may have a bottom section, a nesting section, and a threaded outer surface disposed between the nesting and bottom sections. There may be a plurality of wiring screws configured to attach the bottom section of the male core to the electrical wires from the electrical fixture. The cap may have a feed opening oriented downward and a covering section opposite the feed opening. The feed opening and covering section both may have threaded interior surfaces. Additionally, the feed opening may be configured to threadedly connect with the electrical fixture. The male core can be configured to nest within the female shell by means of a screwed, threaded connection between the female shell threaded interior surface and the male core threaded outer surface. The cap may cover the bottom end of the female shell and secure to the female shell by means of a threaded connection between the female shell exterior surface and cap cover section threaded interior surface.

In accordance with another aspect of the present invention, the electrical fixture connector assembly described above, wherein the securement mechanism includes a circular ridge cut into an outer surface of the male shell that can accept a plurality of protrusion configurations disposed on the female housing interior. In one embodiment, a ball-bearing disposed on the female shell interior, which may be configured to mate with the circular ridge to secure the male and female shells together. In another embodiment described in this disclosure, a securement mechanism also may include a plurality of sliding disks disposed within the female shell that may also mate with the circular ridges of the male shell. The sliding disks may be configured to shift between an unlocked position and a locked position and engage with the male shell circular ridge when in the locked position. The sliding disks can be connected to the decoupling mechanism, wherein the decoupling mechanism is configured to engage the disks to shift the disks between the locked and unlocked positions.

In accordance with another aspect of the present invention, the electrical fixture connector assembly described above, wherein the decoupling mechanism includes a plurality of buttons disposed on an outside surface of the female shell, and wherein the buttons are configured to disengage the securement mechanism.

Other benefits and advantages of this invention will become apparent to those skilled in the art to which it pertains upon reading and understanding of the following detailed specification.

### BRIEF DESCRIPTION OF THE DRAWINGS

The disclosed electrical fixture connector assembly may take physical form in certain parts and arrangement of parts, embodiments of which will be described in detail in this specification and illustrated in the accompanying drawings which form a part hereof and wherein. Based on a particular embodiment:

FIG. 1 is an exploded view of the electrical fixture connector assembly and an exemplary attached electrical fixture;

FIG. 2A is a front view of the quick-connect housing assembly;

FIG. 2B is a view of the male electrical core situated with in a transparent representation of the female housing assembly;

FIG. 2C is an exploded view of the housing assembly and electrical fixture threaded port depicted below the cap feed opening;

FIG. 3A is a front view of the quick-connect base assembly affixed to the quick-connect bracket;

FIG. 3B is a perspective view of the bracket;

FIG. 3C is a section view of the female electrical core;

FIG. 3D is an exploded view of the base assembly;

FIG. 4A is a partial exploded view of the quick-connect housing assembly;

FIG. 4B is a section view of the female shell showing one embodiment of a securement mechanism and decoupling mechanism;

FIG. 4C is a perspective view of a sliding disk used in an exemplary embodiment of the securement mechanism;

FIG. 4D is a top view of the female shell showing the sliding disks of an exemplary embodiment;

FIG. 4E is a cross-sectional side view of an exemplary male shell;

FIG. 4F is cross-sectional side view of the embodiment of FIG. 4A;

FIG. 4G is a bottom view of the embodiment of FIG. 4F;

FIG. 4H is an exploded perspective view of the embodiment of FIG. 4F;

FIG. 5A is a front view of one embodiment of the male electrical core, FIG. 5B is a section view of the embodiment of FIG. 5A, and FIG. 5C is perspective view of the embodiment of FIG. 5A;

FIG. 6 is an alternate embodiment of a female shell;

FIG. 7 is a lighting fixture designed to work with the present invention;

FIG. 8A is an alternate embodiment of the base and junction box as a single unit;

FIG. 8B is an exploded cross-sectional view of the embodiment of FIG. 8A

FIG. 9A is a ceiling fan fixture designed to work with the present invention;

FIG. 9B is an enlarged view of the connection of FIG. 9A;

FIG. 10 is a power cord adapter designed to work with the present invention; and

FIGS. 11A-11C show the alignment and orientation of the male and female electrical cores.

### DETAILED DESCRIPTION OF THE INVENTION

The connection is currently designed as a load bearing male-female connection that is indexed with omni-directional nesting discs or rings that ultimately make the electrical connection, so it can be installed at any orientation. The male connection is part of the junction box adapter and is load bearing. The male portion has ridges that may allow for different female attachment options that will be expanded upon below. This invention contemplates a plurality of ridges or grooves that can be used, the exact number chosen according to sound engineering judgment. The disclosed design allows for any coupling configuration to be joined together with male and female electrical cores as part of the male-female load bearing housings. These parts may be joined by threaded connections or could utilize a set-screw instead that passes through the shell to set the electrical core in place. The female portion is part of the fixture (such as lighting) cord and is brought up to meet the male connection. The user can use one hand to squeeze the unlocking/locking mechanism for attachment while the bulk weight of the fixture is simply held with the opposite hand. The design of squeezing/pressing buttons on the quick-connect housing avoids damaging the ceiling or junction box through excessive upward or twisting force. Additionally, this invention allows retrofitting of existing fixtures, such as an antique chandelier or homemade wooden dining room light, by using the existing fixture's electrical cords/wires with the quick connect assembly described, the quick-connect assembly can then be installed on a junction box that includes the quick connect base/bracket assembly. Further, an electrical fixture may be manufactured with a quick-connect housing and electrical core that can mate with the male shell disposed on the male connection base.

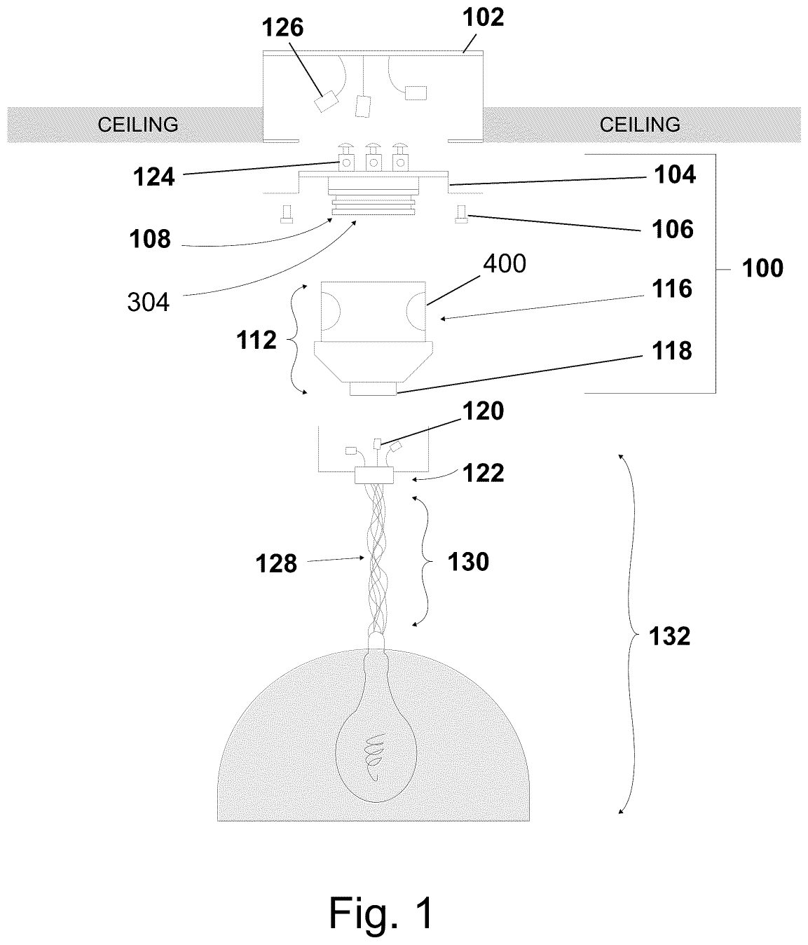

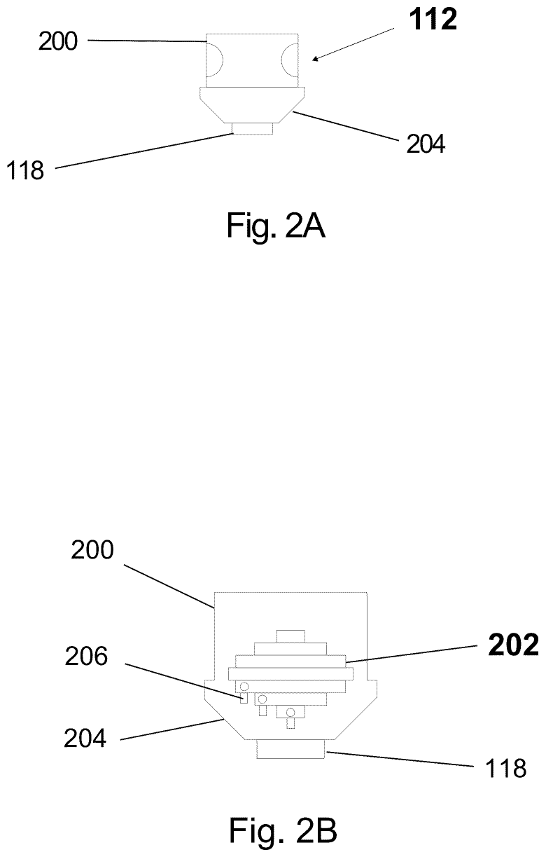

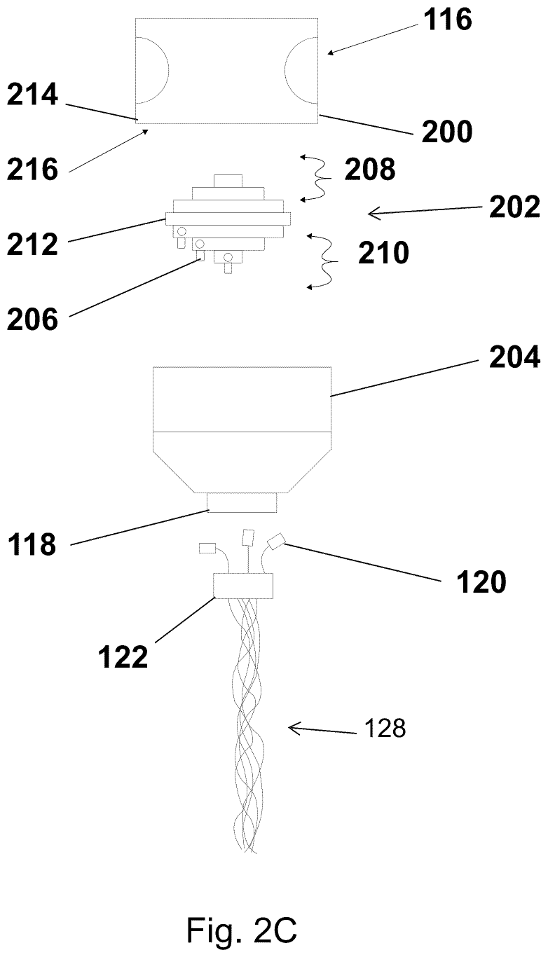

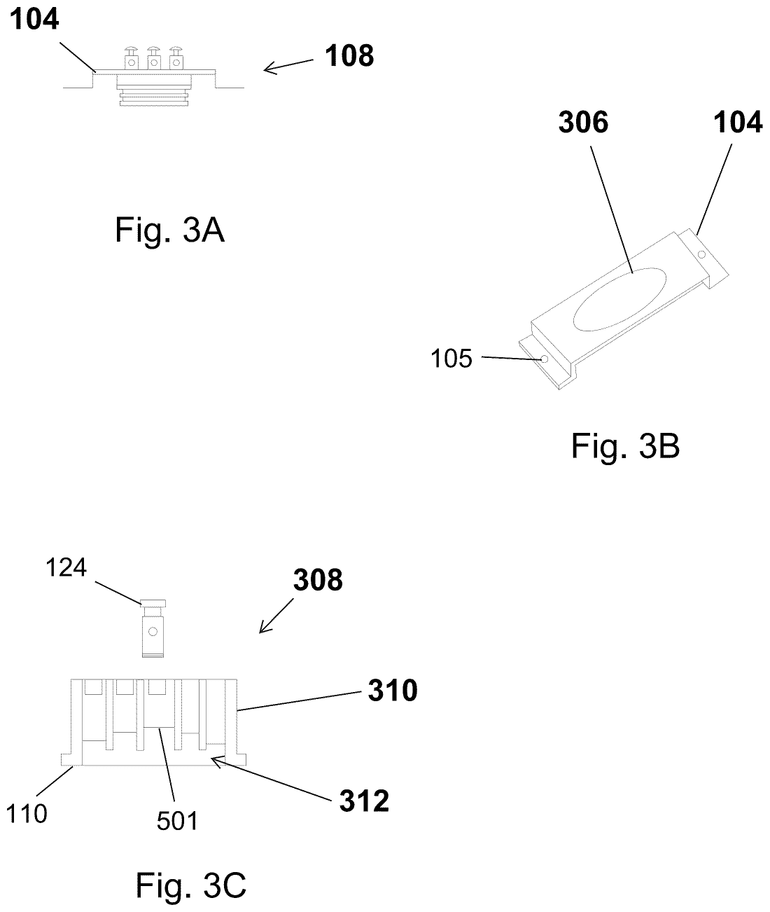

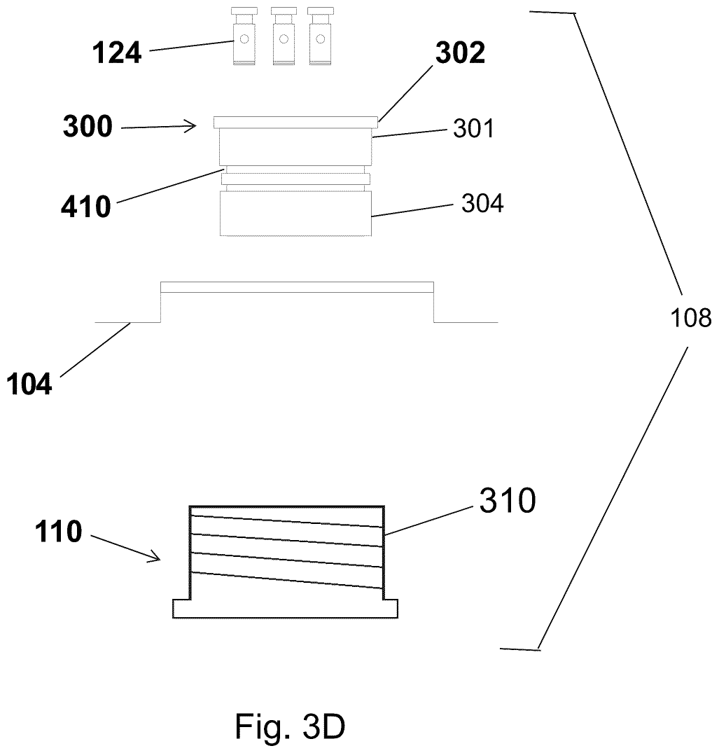

Referring now to the drawings, wherein the showings are for purposes of illustrating embodiments of the invention only and not for purposes of limiting the same, and wherein like reference numerals are understood to refer to like components, FIG. 1 shows an electrical fixture connector assembly 100 according to some embodiments of the present subject matter. The electrical fixture connector assembly 100 may be composed of FIGS. 2A, 3A, and 4A as described below. The electrical fixture connector assembly 100 can provide a quick, electrical, load-bearing connection between an electrical outlet or junction box 102 and a fixture 132 within an enclosure, which includes but is not limited to buildings, offices, showrooms, retail spaces, residences, RVs, awnings, and other facilities. The connector assembly 100 may include a bracket 104, a quick-connect base assembly 108, and a quick-connect housing assembly 112. The bracket 104 may be attached to the electrical outlet or junction box 102 by any fasteners chosen according to sound engineering judgement. In a particular embodiment, the fasteners are screws 106 that may attach at threaded points on a junction box 102. Electrical connectors of any sort chosen according to sound engineering judgement may be used to establish an electrical connection between electrical wires 126, the connector assembly 100, and the electrical fixture electrical wires 120. The bracket 104 and quick-connect base assembly 108 may be maintained as individual units or manufactured as one piece. Additionally, the junction box 102 and quick-connect base assembly 108 could be embodied as a single unit, wherein the junction box 102 and quick-connect base assembly 108 could be manufactured as a single part installed as a substitute for a traditional junction box at the time of initial building construction or renovation. In the embodiment depicted in FIG. 1, and referencing FIGS. 2A and 3A, using a retrofitted fixture as an example, a user may first connect electrical wires 126 within the electrical box 102 to the wiring screws 124 of the quick connect base assembly 108. Then, the quick-connect base assembly 108 with male shell 304 may be secured to the ceiling junction box 102 via the bracket 104 using screws 106. Separately, the quick-connect housing 112 (FIG. 2A) that mates with the quick-connect base assembly 108 may be retrofitted to fit an electrical fixture 132 by connecting to the fixture's electrical wiring 120. The various components of the electrical fixture connector assembly 100 may be configured to nest within one another, as described further below.

Disposed within the male 304 and female 200 shells are first and second mating electrical cores, respectively. In a preferred embodiment, the first electrical core is a female core and the second electrical core is a male electrical core. A second, alternate embodiment includes the arrangement wherein the first electrical core is a male core and the second electrical core is a female electrical core. For the purposes of this disclosure, the preferred embodiment is described below, but the disclosure equally applies to the second embodiment.

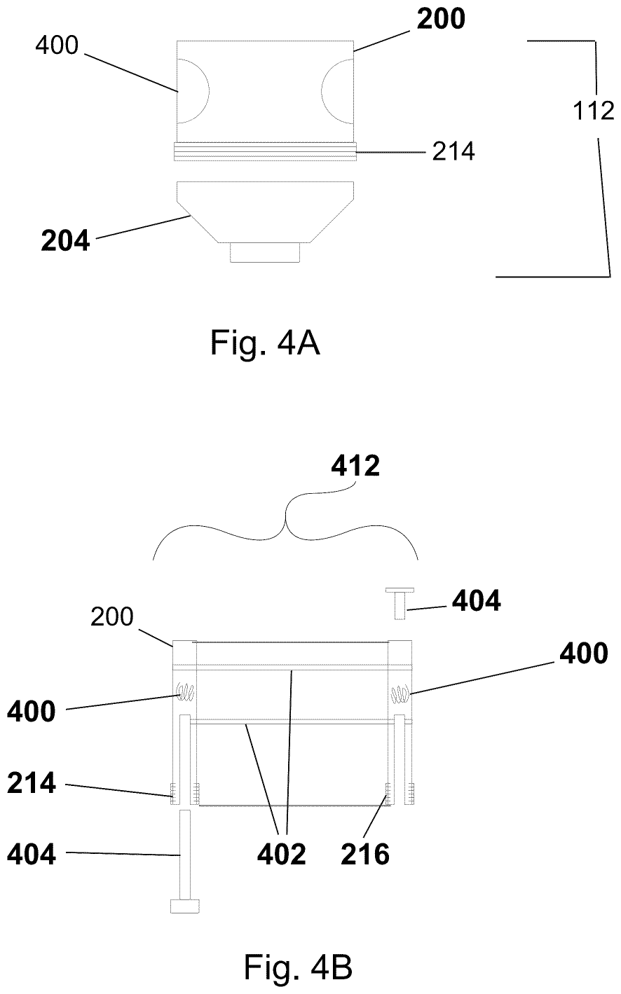

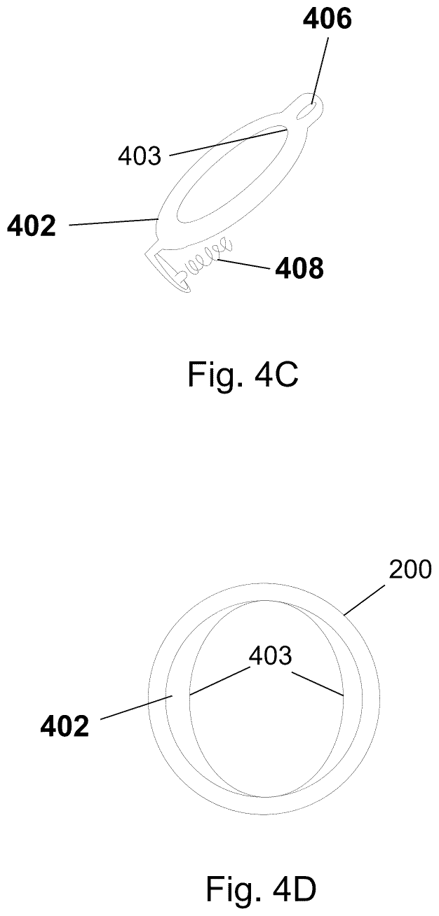

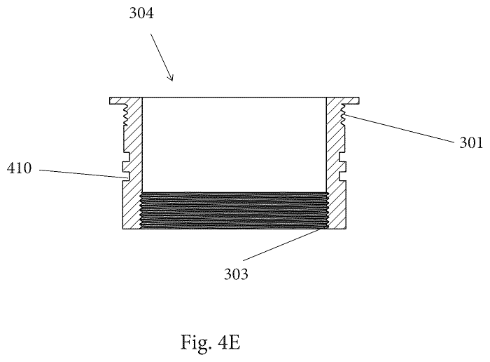

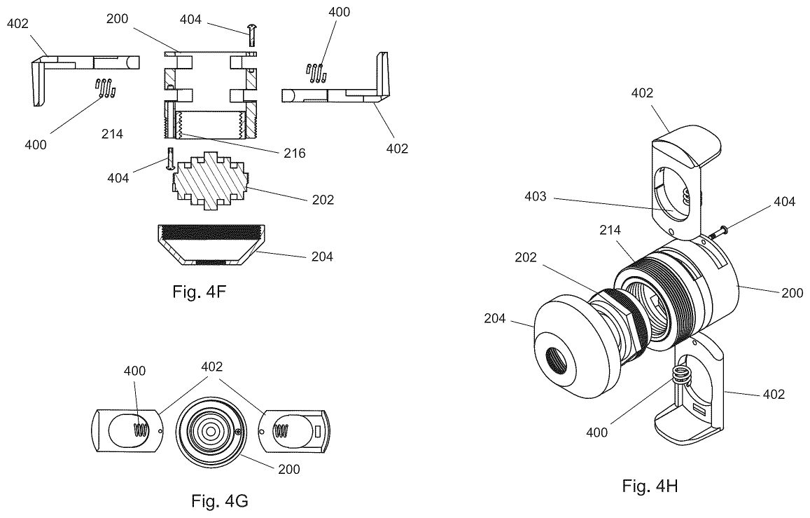

With reference to FIGS. 2A, 2B, and 2C, the quick-connect housing assembly 112 may include a female shell 200, a male electrical core 202, wiring screws 206, and a cap 204. The female shell 200 may have a bottom section, a threaded interior surface 216 (see, FIG. 4B), and a threaded exterior surface 214. The male electrical core 202 may include a bottom section 210, a nesting section (or mating surface section) 208, and a threaded outer surface 212 disposed between the nesting 208 and bottom 210 sections to threadedly meet the interior threading 216 of the female shell 200. The wiring screws 206 may be disposed along the bottom section 210 of the male core 202. The wiring screws may be configured to meet engineering and electrical requirements. The cap 204 may have a feed opening 118 oriented downward and a covering section opposite the feed opening 118. The feed opening 118 and covering section both may have threaded interior surfaces. Additionally, the feed opening 118 may be configured to allow for some other intermediate structure to be installed via attachments including, but not limited to, clamping, pinching, and nesting a cord, chain, or other extension associated with the fixture as part of the décor.

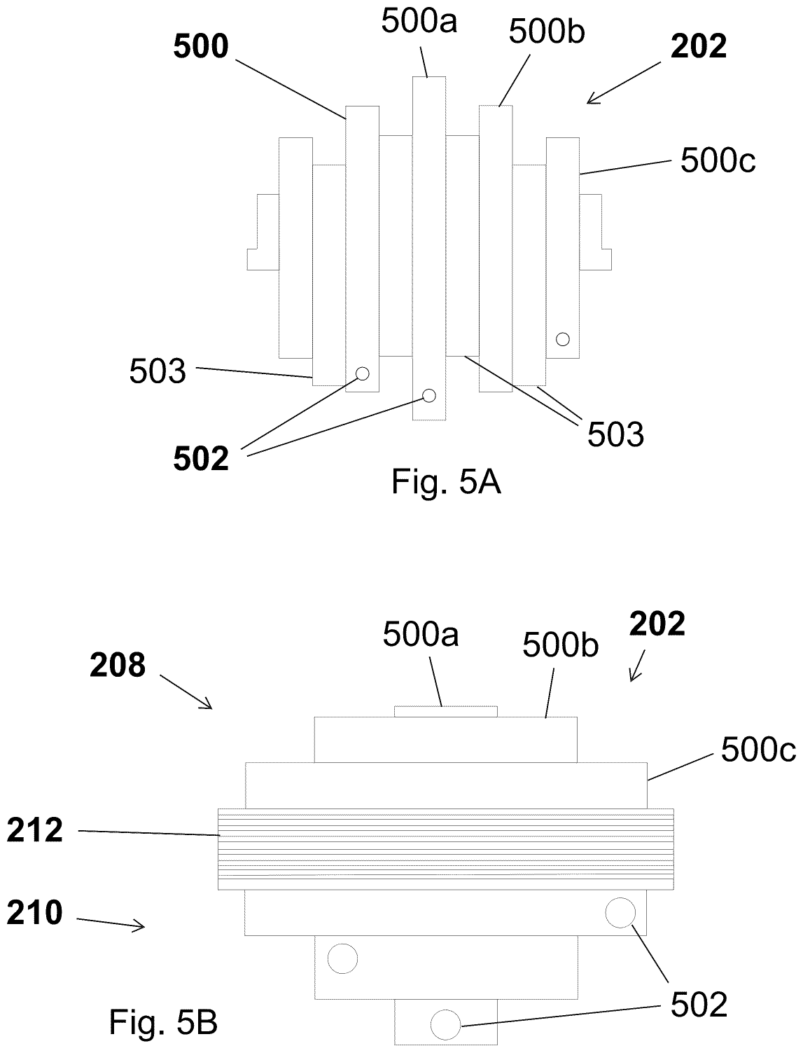

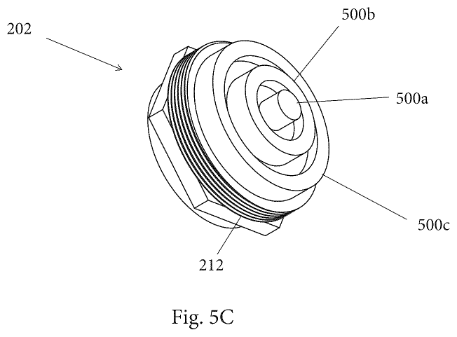

The quick-connect base assembly 108 may include a male shell 304, a female electrical core 110, and wiring screws 124. The male shell 304 may include a lip section 300, disposed around the circumference of a top end, a threaded inner surface, a lip 302 extending outwardly from the lip section 300, and a threaded outer surface 301 disposed around the lip section 300 that may secure to the bracket 104. The female electrical core 110 may have a top section 308, a recessed section (or recessed mating surface section) 312, and a threaded outer surface 310 or set screw channel to secure within the male housing shell, disposed around the top 308 and recessed 312 sections. The top section 308 may include conductive layers 501 that may pass into the recessed section 312 to join with the conductive layers of the nesting section (or mating surface section) 208 of male core 500 (see, FIGS. 5A and 5B) when the quick-connect base assembly 108 and quick-connect housing assembly 112 are secured together. The wiring screws 124 may be disposed upon the top section 308 of the female core 110.

The bracket 104 may include a center cutout 306 with an inner diameter, a first through-hole 105, and a second through-hole 105 disposed opposite the first through which connectors, such as screws, 106 may be used to secure the bracket to the junction box 102.

The male electrical core 202 may include wire inputs 502 that use perpendicular set screws 206 (see, FIGS. 2C, 5B) or may utilize more specialized wiring set screws 124 (See, FIG. 3D) contained within the female shell 200, and/or cover 204 disposed within conductive layers 500 that may present a connection point for electrical wires 120 of the electrical fixture. The conductive layers 500 within the male core may be configured in any possible size, shape, depth, and/or number necessary to meet mounting needs according to sound engineering judgment to ensure the electrical connectivity required by the fixture and its function. An exemplary embodiment is shown in FIGS. 5A and 5B, and includes conductive center post 500a, conductive outer cylinder 500c and conductive intermediate cylinder 500b. Insulating material 503 is disposed between the conductive elements 500a, 500b, 500c.

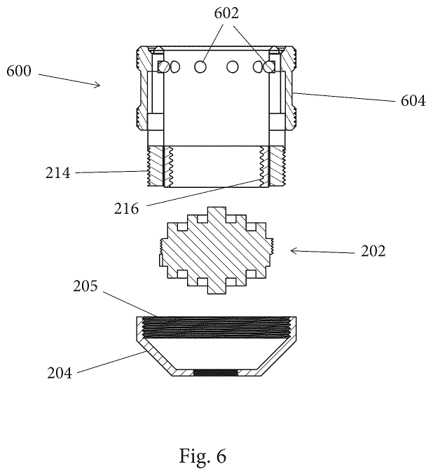

With reference to FIGS. 1, 4A, 4B, 4C, 4D, and 4E, the electrical fixture connector assembly 100 may include a securement mechanism 412 (FIG. 4B). The securement mechanism 412 may be part of the housing assembly 112 and/or female shell 200, and may further include a circular ridge 410 formed in or cut into an outer surface of the male shell 304 (FIG. 4E) to provide a locking site for attachment and locking ball bearings 602 (See FIG. 6) disposed on the female shell 200 interior. Other embodiments of the securement mechanism 412 within the female shell 200 may include a plurality of locking protrusions to fit the circular ridge presented on the male shell 304. It should be noted that any adaptable, coupling configuration may be used to secure the quick-connect housing assembly 112 to the quick-connect base assembly 108, including but not limited to ball bearing clip, sliding disks, inserted pins, and magnetic locks sized to fit the male shell 304. In an alternative embodiment, the securement mechanism 412 may include sliding disks 402 (FIGS. 4B, 4C) disposed within the female shell 200, stop screws 404 disposed within the female shell 200, a screw slot 406 disposed within each sliding disk 402, a decoupling mechanism 116, and a biasing mechanism 408. The stop screws 404 pass through the screw slot 406 and constrain the movement of the disks 402. The sliding disks 402 may be configured to shift between an unlocked position and a locked position and engage with the male shell circular ridge 410 when in the locked position. The disks 402 have an engagement edge 403 that contacts the circular ridge 410 to secure the male shell 304. In the unlocked position, the engagement edge is retracted and no longer contacts the circular ridge 410, to release of the male shell 304. The biasing mechanism biases the engagement edge 403 of the disks 402 to engage the circular ridge 410.

The sliding disks 402 may be situated within the decoupling mechanism 116 and may be connected to a button 400 which when compressed, may compress the biasing mechanism 408 to move the sliding discs out of the locking position with the circular ridges 410 of the male shell 304 and into the unlocking position and decouple the quick-connect housing assembly 112 from the quick-connect base 108. The biasing mechanism 408 may be a spring or alternatively include any mechanical position toggle or alternator chosen according to sound engineering judgement. The decoupling mechanism 116 may include buttons 400 disposed on an outside surface of the female shell 200 and may provide ease in single handed coupling and/or decoupling.

According to one embodiment of the present invention, the various components of the electrical fixture connector assembly 100 may function together to provide a quick, electrical, load-bearing connection between an electrical outlet or junction box 102 and a fixture 132. The bracket 104 secures onto the electrical outlet or junction box, using mechanical connectors, here screws 106. The quick-connect base assembly 108 threadedly connects with, and sits within, the bracket. Electrical wires 126 may be connected to the wiring screws 124 within the female electrical core 110 (FIG. 3C). The female electrical core may be configured to nest within the male shell 304 by means of a screwed, threaded connection between the male shell inner surface threads 303 and threaded female core outer surface 310.

The quick-connect housing assembly 112 connects with the electrical wiring 120,128 of the electrical fixture 132, supported by the electrical fixture suspension 130, which can be made of any material that meets sound engineering judgment, and the electrical fixture suspension 130 may be mechanically connected by the electrical fixture threaded port 122 or set screw to the cap feed opening 118 a final cover, such as a canopy cover, can be included to cover the entire assembly to meet the decor. The male electrical core 202 can be configured to nest within the female shell 200 by means of a screwed, threaded connection between the female shell threaded interior surface 216 (FIGS. 4B and 6) and the male core threaded outer surface 212. The cap 204 may cover the bottom end of the female shell 200 and secure to the female shell 200 by means of a threaded connection between the female shell exterior surface 214 and cap cover section threaded interior surface 205 (See, FIG. 6). Wiring screws 206 may form an electrical connection between the male electrical core 202 and the electrical fixture electrical wiring 120,128, at the bottom section of the male electrical core 210, and within a particular embodiment of wire inputs 502 in the male core conductive layers 500.

With the quick-connect base assembly 108 mechanically secured to the electrical outlet or junction box 102 and electrically connected to the wiring 126, and with the quick-connect housing assembly 112 mechanically connected to the electrical fixture 132 and electrically connected to the electrical fixture wiring 120,128, the base assembly 108 and housing assembly 112 may mate and secure to each other to provide a quick, electrical, load-bearing connection. The male 304 and female 200 shells connect via the securement mechanism 412, as described below. The male electrical core mating surface nesting section 208 connects with the female electrical core mating surface recessed section 312 to complete the electrical circuit between the enclosure and electrical fixture electrical wiring 120,128.

The securement mechanism 412 (FIG. 4B) affixes the housing assembly 112 to the base assembly 108. Activating the securement release mechanism 408 with the decoupling mechanism 116 may shift the sliding disks 402 to the unlocked position and allow the housing assembly 112 to separate from the base assembly 108. Disengaging the decoupling mechanism 116 may shift the sliding disks 402 back into the locked position, causing the engagement edge 403 of the disks 402 to engage with the circular ridge 410 in the base assembly 108. The ridge 410 may include a texture, teeth, protrusions, and/or indentations that interact with complementary textures, teeth, protrusions, and/or indentations on the engagement edge 403, to assist with adjusting rotational orientation and/or to prevent rotation after securement. Thus, the mechanical connection between the base assembly 108 and housing assembly 112 may be completed, securing and suspending the electrical fixture 132. Beyond the foregoing connection method, attachment of the quick-connect housing assembly 112 to the quick-connect base assembly 108 may be accomplished in any manner chosen according to sound engineering judgment. FIG. 4B is not to scale and the space between the disks 402 can be spaced apart, or the disks 402 can contact one another. Moreover, the disks 402 can each engage a separate circular ridge 410 that may be situated at required distances from each other on the male shell 304, or the disks 402 can engage the same circular ridge 410.

An alternate securement mechanism 412 within the female shell 200 is shown in FIG. 6. This embodiment shows a plurality of locking protrusions 602 configured to fit the circular ridge 410 presented on the male shell 304. The protrusions can be ball bearings 602 that are locked in place and unlocked via a slidable collar 604 that engages the ball bearings 602 when the collar is engaged and disengages the ball bearings 602 when the collar 604 is retracted. A spring or other biasing mechanism can be used to bias the collar 604 into the locked/engaged position.

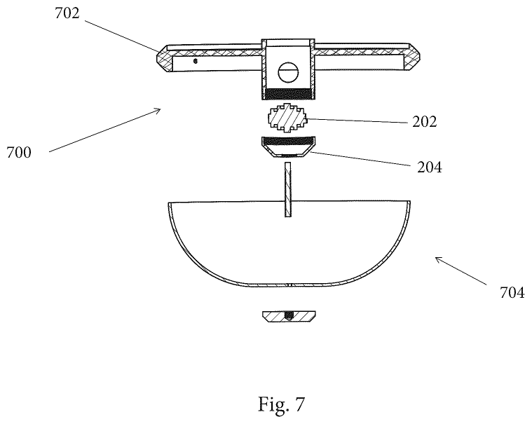

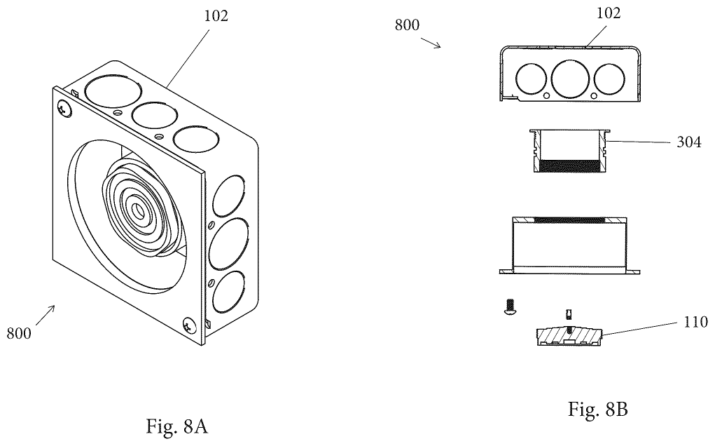

FIG. 7 shows an alternate embodiment 700 of a lighting unit 704 specially designed to work with the present invention includes a male electrical core 202 and a cap 204. An exemplary embodiment is a flush globe ceiling light made specifically to fit the quick-connect connection. The quick-connect may be part of the fixture body where it is visible and accessible when the diffuser is removed. This is an embodiment of a dome light that is not a “retro-fitted” light. It is instead a dome light manufactured with the female shell quick connect to connect via the quick-connect attachment. The present invention represents both an adapter for retro-fitting old fixtures as well as standard features that can be incorporated with manufacture. FIGS. 8A and 8B show a junction box 800 that include the quick connect connections.

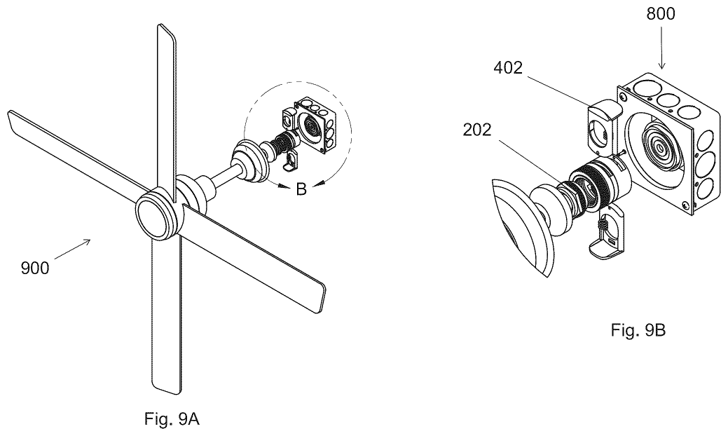

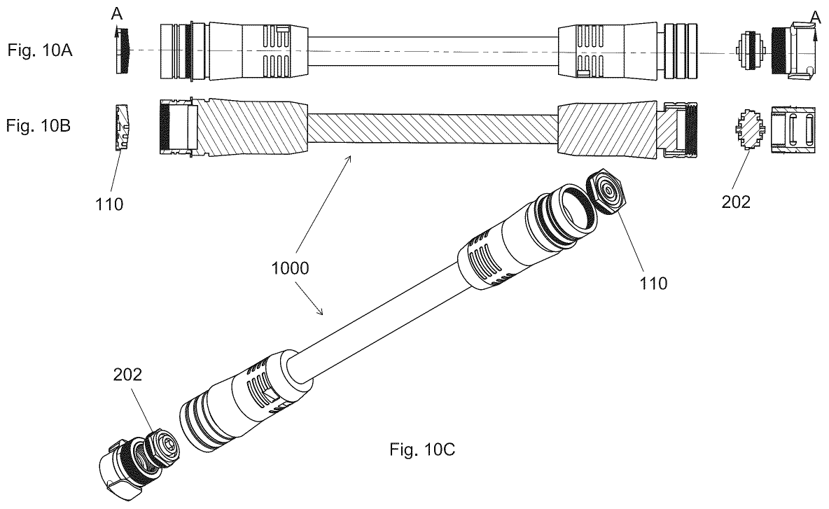

In summary, the quick-connect base 108, and its male shell 304, are the primary component attached to the junction box 102, or are manufactured as a complete, single quick-connect-junction-box combination unit 800 (FIG. 8A), to which the plurality of female shell 200 attachments connect. Various fixtures and/or lamps can be manufactured to directly attach to the base 108. For example, a pendant lamp made to meet the connection may have two approaches: (1) The button for the release mechanism may be built into the ceiling canopy cover; (2) The button for the release mechanism may be part of the coupling that becomes covered by the canopy cover after connection. In another example. In addition, a wall mounted light may be made specifically to fit the connection, similar to the pendant light described above. In another example, a ceiling fan 900 (FIG. 9A) can be made specifically to fit the connection. FIG. 9B shows a button for the release mechanism as part of the coupling that becomes covered by the canopy. Another example includes an extension cord connection for strung lights with a cover, or a general extension cord connection with a cover 1000 (FIG. 10).

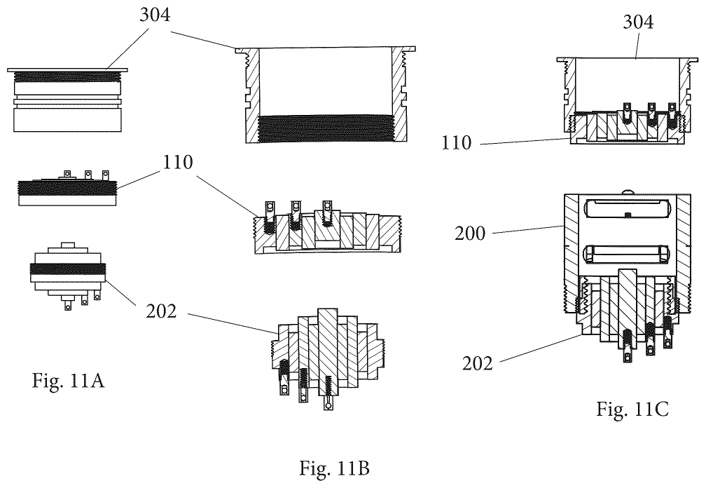

FIGS. 11A-C show how the male 202 and female 110 cores align and fit within the female 200 and male 304 shells respectively.

The invention features may allow the primary components to remain adaptable for a plurality of coupling configurations to be incorporated to meet engineering requirements or work scope that require pre-existing configurations which affect such couplings as quick-connects, cam and grooves, ball and sleeve, and twist claws. Adaptability for a plurality of coupling configurations is made possible by utilizing any chosen mating male 304 and female 200 shells that accept the male 202 and female 110 electrical cores that are configured to meet the scope of electrical requirements. Additionally, the relative positions and connections of the quick-connect housing assembly 112 and quick-connect base assembly 108 may be inverted in some embodiments.

Although the invention has been shown and described with respect to certain embodiments, equivalent alterations and modifications will occur to others skilled in the art upon the reading and understanding of this specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer which performs the specified function of the described integer (i.e., that is functionally equivalent), even though not structurally equivalent to the disclosed structure which performs the function in the herein illustrated exemplary embodiment of the invention.

What is claimed:

1. An electrical fixture connector assembly, comprising:
a base assembly having a male shell and a first electrical core;
wherein the first electrical core is configured to nest within the male shell;
wherein the first electrical core is configured to accept electrical wires from an electrical outlet or junction box;
a housing assembly having a female shell and a second electrical core;
wherein the second electrical core is configured to nest within the female shell; and
wherein the second electrical core is configured to accept electrical wires from an electrical fixture;
wherein the first and second cores are configured to mate with one another to form an electrically conductive connection;
wherein the male and female shells are configured to mate with one another to form a load-bearing mechanical connection.

2. The electrical fixture connector assembly of claim 1, wherein the first electrical core is a female electrical core and the second electrical core is a male electrical core.

3. The electrical fixture connector assembly of claim 1, wherein the first electrical core is a male electrical core and the second electrical core is a female electrical core.

4. The electrical fixture connector assembly of claim 1, further comprising a bracket that includes:
a center cutout with an inner diameter, a first through-hole, and a second through-hole disposed opposite the first;
wherein the center cutout is configured to accept and the hold base assembly.

5. The electrical fixture connector assembly of claim 2, wherein the base assembly further comprises:
the male shell having a lip section, disposed around a circumference of a top end, a threaded inner surface, a lip extending outwardly from the lip section;
the female electrical core having a top section, a recessed mating surface section, and a connecting outer surface disposed around the top and recessed mating surface sections, the connecting outer surface selected from a threaded outer surface and a surface configured to receive one or more set screws;
a connection means configured to attach the top section of the female core to the electrical wires from the electrical outlet or junction box;
wherein the female core is configured to nest within the male shell by threaded connection between the male shell inner surface and female core outer surface.

6. The electrical fixture connector assembly of claim 5, further comprising:
a bracket that includes a center threaded hole;
wherein the male shell further comprises a threaded outer surface disposed around the lip section configured to attach to the center threaded hole.

7. The electrical fixture connector assembly of claim 5, wherein the connection means comprises a plurality of wiring screws.

8. The electrical fixture connector assembly of claim 2, wherein the housing assembly further comprises:
the female shell having a bottom end and a connecting surface selected from a threaded interior surface and a surface configured to receive one or more set screws;
the male electrical core having a bottom section, a mating surface section, and a connecting surface disposed between the mating surface and bottom sections, the connecting surface selected from a threaded outer surface and a surface configured to receive the one or more set screws;
a connection means configured to attach the bottom section of the male core to the electrical wires from the electrical fixture;
wherein the male core is configured to nest within the female shell by a threaded connection between the female shell threaded interior surface and the male core threaded outer surface.

9. The electrical fixture connector assembly of claim 8, wherein the female shell further comprises an exterior connection surface selected from a threaded exterior surface and a surface configured to receive one or more set screws.

10. The electrical fixture connector assembly of claim 9, further comprising a cap having a feed opening oriented downward and a covering section opposite the feed opening;
wherein the feed opening and covering section have threaded interior surfaces;
wherein the feed opening is configured to connect with the electrical fixture;
wherein the cap covers the bottom end of the female shell and secures to the female shell by a threaded connection between the female shell exterior surface and cap cover section threaded interior surface.

11. The electrical fixture connector assembly of claim 8, wherein the connection means comprises a plurality of wiring screws.

12. The electrical fixture connector assembly of claim 1 further comprising:
a securement mechanism;
a decoupling mechanism;
wherein the housing assembly attaches to the base assembly by means of the securement mechanism; and
the housing assembly detaches from the base assembly by means of the decoupling mechanism.

13. The electrical fixture connector assembly of claim 12, wherein the securement mechanism comprises:
at least one circular ridge formed in an outer surface of the male shell;
a nesting structure disposed on the female shell configured to mate with the at least one circular ridge disposed on the surface of the male shell.

14. The electrical fixture connector assembly of claim 13, further comprising a ball-bearing connector configured to mate with the circular ridge to secure the male and female shells together.

15. The electrical fixture connector assembly of claim 14 wherein the nesting structure includes one or more ball bearings configured to mate with the circular ridge to secure the male and female shells together.

16. The electrical fixture connector assembly of claim 12, wherein the securement mechanism comprises:
at least one circular ridge formed in an outer surface of the male shell;
at least one sliding disk disposed within the female shell;
wherein the at least one sliding disk is configured to shift between an unlocked position and a locked position;
wherein the at least one sliding disk is configured to engage with the male shell circular ridge when in the locked position;
wherein the at least one sliding disk is connected to the decoupling mechanism; and
wherein the decoupling mechanism is configured to engage the at least one sliding disk to shift the disk between the locked and unlocked positions.

17. The electrical fixture connector assembly of claim 16, wherein the securement mechanism further comprises a biasing mechanism attached to the at least one sliding disk configured to bias the at least one sliding disk to the locked position.

18. The electrical fixture connector assembly of claim 12, wherein the decoupling mechanism comprises:
a plurality of buttons disposed on an outside surface of the female shell; and
wherein the buttons are configured to disengage the securement mechanism.

19. An electrical fixture connector assembly, comprising:
a base assembly having a male shell and a female electrical core;
wherein the female electrical core is configured to nest within the male shell;
wherein the female electrical core is configured to accept electrical wires from an electrical outlet or junction box;
wherein the female electrical core is configured to mate with one or more male electrical cores to form an electrically conductive connection;
wherein the male shell is configured to mate with one or more female shells to form a load-bearing mechanical connection.

20. An electrical fixture connector assembly, comprising:
a housing assembly having a female shell and a male electrical core;
wherein the male electrical core is configured to nest within the female shell; and
wherein the male electrical core is configured to accept electrical wires from an electrical fixture;
wherein the male electrical core is configured to mate with one or more female electrical cores to form an electrically conductive connection;
wherein the female shell is configured to mate with one or more male shells to form a load-bearing mechanical connection.
